(19) United States
(12) Patent Application Publication
(10) Pub. No.: US 2014/0144767 A1
(43) Pub. Date: May 29, 2014

(54) METHOD AND APPARATUS FOR VACUUM DISTILLATION

(71) Applicants: Patrick N. Jost, Steinham Am Albuch (DE); Jan Welzien, Schwabach (DE)

(72) Inventors: Patrick N. Jost, Steinham Am Albuch (DE); Jan Welzien, Schwabach (DE)

(73) Assignee: Hans Heidolph GmbH & Co. KG, Kelheim (DE)

(21) Appl. No.: 14/090,687

(22) Filed: Nov. 26, 2013

(30) Foreign Application Priority Data
Nov. 29, 2012 (DE) 102012221887.4

(51) Int. Cl. B01D 3/10; B01D 3/42

(52) U.S. Cl. CPC B01D 3/10; B01D 3/42
USPC 203/2; 202/205

(57) ABSTRACT

The invention relates to a method for the vacuum distillation of a liquid, in particular by means of a rotary evaporator, wherein at least one fraction of the liquid is evaporated at a reducing pressure, a vapor temperature correlating with a boiling temperature is determined by means of a temperature sensor and a pressure present at the time of the determination of the vapor temperature and correlating with a boiling pressure is determined and a minimal pressure, which may not be undercut in the distillation, is automatically determined by using the determined vapor temperature and to the determined pressure.

The present invention relates to a method for the vacuum distillation of a liquid, in particular by means of a rotary evaporator, in which at least one fraction of the liquid is evaporated at a reducing pressure.

A rotary evaporator is a piece of laboratory equipment which includes a heating bath and an evaporator flask which can be immersed into the heating bath. In operation, a liquid medium present in the heating bath, for example water or—for higher temperatures—oil, is heated in order thus to heat the evaporator flask immersed into the heating bath. A liquid, in particular a liquid mixture, contained in the evaporator flask can hereby be heated so that the respective distillate, in particular a solvent, is evaporated. The evaporated distillate then flows into a cooler of the rotary evaporator to condense there. The condensate is subsequently collected in a collection flask. A rotary evaporator furthermore includes a rotary drive for the rotation of the evaporator flask in the heating bath. The evaporator flask is uniformly heated due to the rotation and a thin liquid film which has a large surface and from which the distillate can be evaporated fast, efficiently and gently is produced at the heated inner wall of the evaporator flask. The distillation residue remaining in the evaporator flask can be further processed or analyzed.

A vacuum pump is additionally provided for producing a vacuum or partial vacuum in the evaporator flask and the cooler. The vacuum pump is typically connected to a vacuum connector of the cooler to lower the boiling temperature. This is in particular of advantage when the substance which is dissolved in the liquid and which should remain in the evaporator flask as a valuable product at the end of the evaporation is temperature-sensitive and undergoes the risk of being broken down at too high a boiling temperature.

The composition of the liquid or the concentration of the substance dissolved in the liquid, however, varies continuously due to the evaporation, from which a shift of the boiling point curve of the liquid toward higher temperatures or an increase in the boiling temperature results. To be able to carry out the evaporation at a constant heating bath temperature, the applied partial vacuum therefore has to be increased or the system pressure has to be reduced, i.e. a pressure tracking has to take place. A regulation of the heating bath temperature would, in contrast, be very slow and boiling temperatures which are too high carry the risk of a breaking down of the substance to be evaporated—as mentioned above. An automatic lowering of the system pressure can be realized, for example, by means of a vacuum controller. The system pressure is in this respect controlled such that it is not too high, on the one hand, so that the evaporation would take an unnecessarily long time, and is not too low, on the other hand, to avoid a foaming or overfrothing of the liquid or a boiling delay, in particular on too great a pressure drop.

Care must, however, be taken with a continuous pressure reduction that the pressure is not lowered so far that the condensate, which is at room temperature as a rule, re-evaporates from the collection flask and may not condense sufficiently in the cooler and then escapes into the atmosphere in an uncontrolled manner via the vacuum pump. It is furthermore not conducive to the service life of a vacuum pump if the vacuum pump comes into contact with a solvent.

To avoid this, a final pressure, i.e. a minimal pressure or a lower limit for the system pressure, under which the pressure or lower limit the system pressure should not be reduced, can be set manually by an operator. The suitable choice of the final pressure depends, however, on the respective liquid used or on the composition of the respective liquid and therefore requires knowledge of the thermodynamic material data of the liquid. If the final pressure is selected too high and if the evaporation is thus stopped too soon, the evaporated solvent cannot be completely reclaimed. If the final pressure is, in contrast, selected too low, the problems named above occur.

It is therefore the underlying object of the invention to provide a method of the initially named kind which ensures an evaporation of a liquid or at least of one fraction thereof which is as complete as possible while avoiding a re-evaporation of a condensate.

This object is satisfied by a method having the features of claim 1 and in particular in that a vapor temperature correlating with a boiling temperature is determined by means of a temperature sensor and a pressure present at the time of the determination of the vapor temperature and correlating with a boiling pressure is determined by means of a pressure sensor and a minimal pressure, which is not undercut in the distillation, is automatically determined using the determined vapor temperature and the determined pressure.

The minimal pressure is the aforesaid final pressure, which is not undercut in the continuous pressure reduction. The pressure can in particular fall at a constant rate. A constantly reducing pressure is also present when the system pressure is lowered step-wise or partially step-wise. An evaporation at a reducing pressure in the sense of the present application is also present when the system pressure development has singularities with a rising pressure with an at least unchanging or rising pumping power of the vacuum pump on an occurrence of specific events which directly increase the system pressure as is, for example, the case on the start of the evaporation, on an addition of additional liquid during the evaporation or on the start of the evaporation of a further fraction.

The liquid can, for example, be a solvent or a solvent mixture so that the liquid or at least one fraction of the liquid is evaporated in the distillation.

The determined vapor temperature correlates with a boiling temperature of the liquid or at least of the fraction thereof and the determined pressure correlates with the boiling pressure associated with the named boiling temperature. The determined vapor pressure in particular corresponds to the current boiling temperature and the determined pressure corresponds to the current boiling pressure. A conclusion can therefore be drawn from the determined vapor temperature and the determined pressure on a boiling point of the liquid, or at least of the fraction, which covers the named boiling temperature and the named boiling pressure. Since the boiling point curves of different liquids, in particular solvents or solvent mixtures, show comparable developments, as will be explained in more detail below, a limit boiling pressure of the liquid or at least of the fraction can be determined using the named boiling point, said limit boiling pressure being present at room temperature or at the temperature at which the condensate lies and being a pressure which may not be undercut to prevent a re-evaporation of the condensate. The minimal pressure then in particular corresponds to this limit boiling pressure or to a pressure which lies above the limit boiling pressure by an offset which defines a sufficient “safety distance” to be able to compensate measurement tolerances, system fluctuations and the like.

Since the minimal pressure is automatically determined by the rotary evaporator or by a distillation apparatus from the vapor temperature determined by means of the temperature sensor and from the pressure determined approximately at the time of the determination of the vapor temperature by means of the pressure sensor, no knowledge of the thermodynamic material data of the liquid is required on the part of the operator. The operation of the rotary evaporator or of the distillation apparatus can therefore be automated and thereby be simplified.

The value pair comprising the determined vapor temperature and the determined pressure can be associated with a stored characteristic line, in particular with an array of characteristic lines, to determine the minimal pressure. The characteristic line is in particular the aforesaid development of the boiling point curve and the characteristic lines of the array of characteristic lines are associated with different boiling point curves of different liquids. The respective characteristic line can be stored, for example, as table values or as an analytical function.

A pressure can in particular be associated with a predefined reference temperature by means of the characteristic line, with the pressure being determined as the minimal pressure. The predefined reference temperature is preferably the temperature of the condensate, in particular room temperature, or a temperature which lies above the temperature of the condensate by an offset in order reliably to prevent a re-evaporation of the condensate.

The determined vapor temperature and the determined pressure can be determined on the start of the evaporation. The start of the evaporation can in particular be recognized with reference to at least one measured value of at least one measurement parameter of the evaporation, in particular with reference to a measured temperature value and/or to a measured pressure value, preferably with reference to the time development of the at least one measurement parameter. The start of the evaporation can, for example, be recognized by an increase, in particular a high increase, in the temperature or in the pressure at the temperature sensor or at the pressure sensor respectively or by an increase which exceeds a predefined threshold value. The temperature increase is triggered by the incipient hot vapor which flows past the temperature sensor. A fall in the vapor temperature correspondingly indicates the end of the evaporation. The pressure increase is likewise effected by the vapor flow occurring at the start of boiling. The temperature present directly after the temperature increase then in particular corresponds to a boiling temperature of the liquid or of the fraction thereof and the pressure present at this time corresponds to the boiling pressure associated with this boiling temperature.

The distillation is in particular preferably automatically ended at the latest on a reaching of the minimal pressure. This is as a rule also not disadvantageous with respect to an evaporation which is as complete as possible since, typically, hardly any vapor is produced at this time, i.e. only a low efficiency is reached in the distillation. It is, however, generally also possible that the distillation is continued at a constant minimal pressure. The distillation can, however, also be ended at an earlier time, in particular when it is determined by the temperature sensor that the vapor temperature falls to a degree that allows a conclusion on the end of the evaporation due to an almost complete distillation of the solvent.

The pressure tracking in particular using a vapor temperature measured continuously by means of the temperature sensor or of a further temperature sensor arranged in the cooler is preferably regulated automatically—in particular directly subsequent to the start of the evaporation—for example, by means of a vacuum pump controlled by revolution speed. The system pressure in this respect falls continuously overall. If the respective temperature sensor determines that the vapor temperature drops while exceeding a predefined degree since less vapor is instantaneously being produced and is thus flowing past the temperature sensor due to the boiling point shift with a continuous evaporation, the system pressure is lowered further so that—providing sufficient liquid to be evaporated is still present—the drop in the vapor temperature is at least partly compensated and/or is set to a predefined level.

In accordance with an embodiment of the invention, a respective vapor temperature can be measured at a plurality of points arranged after one another in the flow direction of the vapor to determine, in particular to regulate, the position of a condensation front of the vapor. This is of advantage since it can occur that at too high an evaporation rate, triggered by too low a system pressure, the cooler can no longer completely condense the vapor and some of the vapor is sucked off by the vacuum pump so that the above-discussed disadvantages occur which are associated therewith. How far the vapor has risen in a rising cooler can be determined by the spatially distributed temperature measurements. If, for example, with four temperature sensors uniformly distributed over the height of the cooler, the significant temperature increase can only be observed at the two bottommost temperature sensors, the conclusion can be drawn that the vapor has risen up to approximately half the height of the cooler. To produce as much distillate as possible within a given time, it is advantageous if the vapor rises as far as possible in the cooler to provide a condensation surface which is as large as possible. The height of the vapor column can be regulated by a corresponding pressure control, in particular such that only the topmost sensor does not measure a temperature increase. The same also applies accordingly to a falling cooler or other cooler.

A current pressure gradient is preferably compared with a predefined limit value to limit the pressure drop to a maximum permitted value. A foaming of the liquid and/or a boiling delay can thus be countered.

It is generally possible that the composition of the liquid or the at least one fraction is determined from the determined vapor temperature and the determined pressure.

In accordance with a further embodiment of the invention, the vapor of at least the fraction condenses in a cooler and the condensate is collected in a collection vessel, with the collection vessel being cooled, in particular by means of a corresponding cooling device and/or by condensate vapor rising from the collection vessel, in particular in a cooling device interposed between the cooler and the collection vessel, before a flowing back into the cooler. The start of the re-evaporation of the condensate into the cooler can be displaced toward low system pressures by lowering the temperature of the condensate so that the minimal pressure can lie at lower values in comparison with an uncooled collection vessel. The cooling medium of the condensate cooling device preferably has a temperature which lies below the temperature of the cooling medium associated with the cooler.

It is in particular of advantage in this connection if the temperature of the condensate is determined by a condensate temperature measuring sensor. If the condensate is cooled by a cooling device, the temperature measuring sensor can, however, also be associated with the cooling device.

The invention further relates to a distillation apparatus, in particular to a distillation apparatus configured as a piece of laboratory equipment, in particular a rotary evaporator, for the vacuum distillation of a liquid, having a distillation vessel for evaporating at least one fraction of the liquid at a reducing temperature, having at least one temperature sensor for determining a vapor temperature correlating to a boiling temperature and having a pressure sensor for determining a pressure present at the time of the determination of the vapor temperature and correlating with a boiling pressure, wherein the distillation apparatus is adapted to determine a minimal pressure automatically using the determined vapor temperature and the determined pressure, said minimal pressure not being undercut in the distillation.

The temperature sensor or the first of a plurality of temperature sensors is preferably arranged at the outlet of the distillation vessel and/or at the inlet of a cooler of the distillation apparatus. At this point the temperature of the vapor relatively exactly corresponds to the current boiling temperature of the liquid or of the fraction thereof.

Further preferred embodiments of the apparatus in accordance with the invention result in an analog manner from the further developments of the method in accordance with the invention. The apparatus in accordance with the invention, in particular the respective corresponding component of the apparatus in accordance with the invention, is adapted to carry out the respective corresponding method step. A plurality of temperature sensors arranged next to one another in the flow direction of the vapor, in particular in the cooler, can in particular be provided to determine, in particular to control, the position of a condensation front of the vapor.

Advantageous embodiments of the invention are set forth in the dependent claims, in the description and in the drawing.

A non-restricting embodiment of the invention is represented in the drawing and will be described in the following. There are shown,

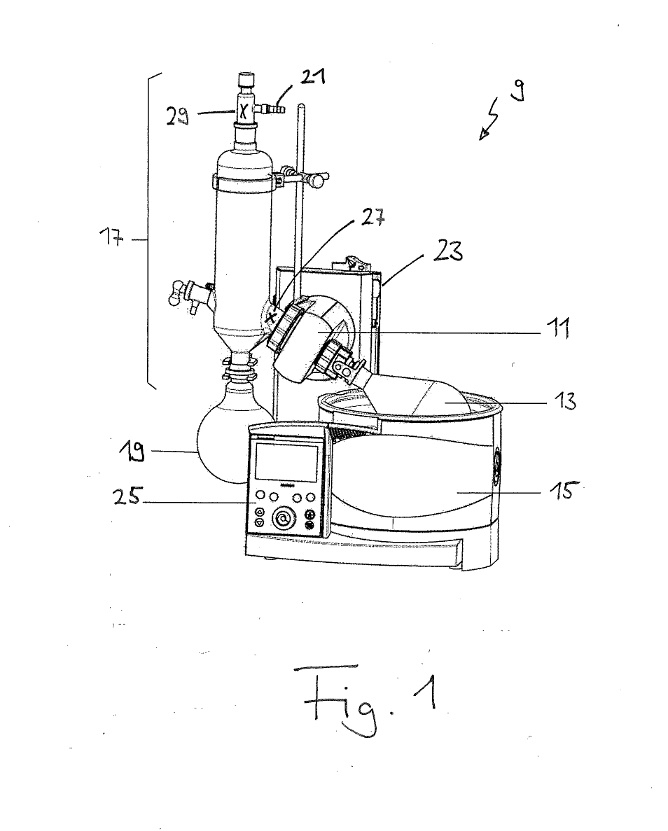

FIG. 1 a perspective view of a rotary evaporator; and

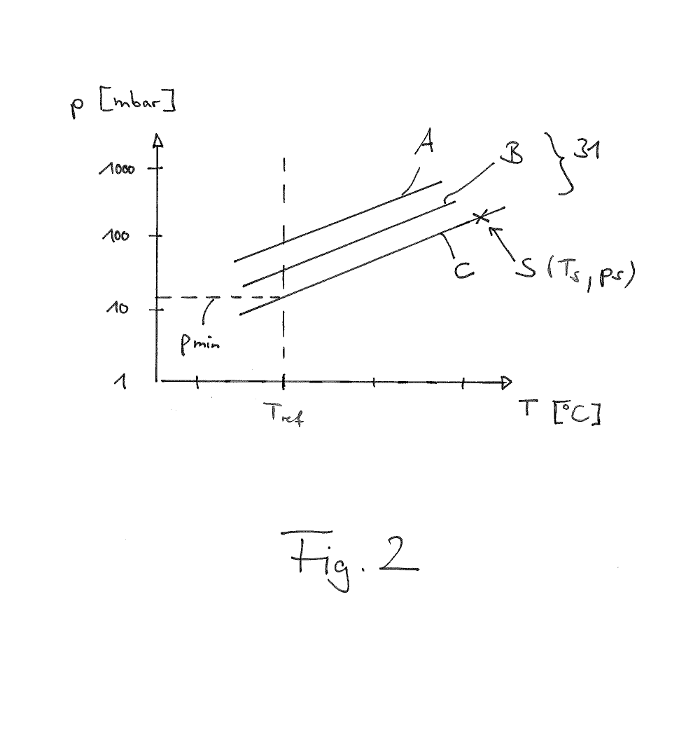

FIG. 2 a phase diagram of different liquids at the transition “liquid—gaseous” in a simple logarithmic representation.

The rotary evaporator 9 shown in FIG. 1 comprises a rotary drive 11 with a vapor conduit for an evaporator flask 13 which is e.g. configured as a round flask or as a V flask and which can be rotatably heated in a heating bath 15 to evaporate a solvent located therein. The evaporated solvent then moves via the vapor conduit led through the rotary drive 11 into a cooler 17 to condense there. The condensed distillate is then collected in a collection flask 19.

A vacuum connector 21 is provided at the cooler 17 to apply a vacuum or a partial vacuum generated by a vacuum pump to the cooler 17 and to the evaporator flask 13, whereby the boiling temperature for the distillate can be lowered. The rotary evaporator 9 additionally comprises a lift 23 which carries the rotary drive 11 and can move it in the vertical direction to lower the evaporator flask 13 into the heating bath 15 or to lift it out of it. The rotary evaporator 9 furthermore comprises a control panel 25 for controlling the temperature of the heating bath 15, of the rotary drive 11, of the vacuum pump, and of the lift 23.

A temperature sensor 27 drawn schematically in FIG. 1 is provided at the inlet of the cooler 17 to determine the current temperature of the vapor exiting the evaporator flask 13. Furthermore, the current system pressure present in the cooler 17 and in the evaporator flask 13 can be determined using a likewise schematically drawn pressure sensor 29.

As the evaporation process starts, the temperature at the temperature sensor 27 rises abruptly so that the start of the evaporation can hereby be recognized. The measured vapor temperature then at least substantially corresponds to the currently present boiling temperature of the solvent. The system pressure present at this time, which then corresponds to the currently present boiling pressure, is then also measured by the pressure sensor 29.

Since the concentration of the substance dissolved in the solvent varies as the evaporation runs, the system pressure is continuously lowered, i.e. the partial pressure is continuously increased to counter a boiling temperature shift toward higher temperatures and to be able to carry out the evaporation at a constant heating bath temperature. The temperature of the vapor in the cooler 17 measured for the pressure tracking remains largely constant in this respect.

Since the collection flask 19 is in fluid communication with the cooler 17 and with the evaporator flask 13, the respective partial pressure is, however, also applied at the collection flask 19 in which the condensed solvent is located, as a rule at approximately room temperature. If the system pressure were to be reduced down to a pressure which corresponds to the boiling pressure of the solvent at room temperature, a re-evaporation of the condensed solvent from the collection flask 19 would take place in the cooler 17. This has to be avoided, however, since the solvent may damage the vacuum pump generating the partial vacuum under certain circumstances and can escape via it in an uncontrolled manner into the environment.

A minimal pressure is therefore automatically determined by the rotary evaporator 9 and is not undercut in the evaporation. The distillation is rather ended once the minimal pressure is reached. The minimal pressure is in this respect selected such that it is not below the pressure at which the aforesaid re-evaporation of the condensed solvent from the collection flask 19 would take place.

In accordance with the invention, the minimal pressure is automatically determined by the rotary evaporator 9 itself. A measured boiling point of the solvent, in particular the boiling point measured at the time of the start of the evaporation, is used for this automatic determination of the minimal pressure. In this respect, it is not necessary to known which solvent or which solvent mixture is being distilled.

This is due to the fact that the boiling point curves of at least all conventional solvents and solvent mixtures follow the generally valid equation

p=a2^{(T/20K)-1} (1)

at least in a good approximation, where p is the boiling pressure, T is the boiling temperature [in Kelvin] and a is a material-specific constant, i.e. a change in the boiling temperature by 20° C. results in a halving or doubling of the building pressure.

A corresponding rearrangement of equation (1) produces

log₂ p=(log₂ a−1)+20K/1T (2)

i.e. the boiling point curves are represented by straight lines in a semi-logarithmic representation, with all the boiling point curves having substantially the same gradient independently of the specific solvent or solvent mixture. Only the axial sections can differ material-specifically from one another. Corresponding characteristic lines 31 for different solvents A, B and C are shown with different axial sections in FIG. 2.

A boiling pressure which the respective solvent has at room temperature, i.e. in particular at 20° C., can be calculated using equation (1) or equation (2) on the basis of a measured boiling point, i.e. of a measured boiling temperature and a measured associated boiling pressure of the solvent to be evaporated. This pressure, which is calculated or is taken from stored tables, then corresponds to the minimal pressure which may not be undercut during the distillation to avoid a re-evaporation of the solvent from the collection flask 19. A boiling point S measured at the start of the evaporation, a temperature T_{ref}, at which the condensed solvent lies, and the associated minimal pressure pₘᵢₙ are shown by way of example in FIG. 2 for the solvent C.

A plurality of temperature sensors arranged after one another in the flow direction of the vapor can also be provided in the cooler 17. A multipoint measurement makes it possible to determine how far the vapor has risen in the cooler 17. It generally applies in this respect that the height of the vapor column in the cooler 17 is the larger, the smaller the system pressure is at the same concentration of the substance dissolved in the solvent. The pressure can in this respect be regulated such that the height of the pressure column is maximized where possible, but such that it is simultaneously prevented that the height of the vapor column exceeds the height of the cooler 17. This would namely have the result that the vapor would then be sucked off by the vacuum pump, which is disadvantageous, as was already explained above.

The method in accordance with the invention and the apparatus in accordance with the invention allow an automatic final pressure determination for the respective distillation so that no knowledge of the solvent or solvent mixture to be evaporated is required.

### REFERENCE NUMERAL LIST

9 rotary evaporator
11 rotary drive
13 evaporator flask
15 heating bath
17 cooler
19 collection flask
21 vacuum connector
23 lift
25 control panel
27 temperature sensor
29 pressure sensor
31 characteristic line
pₘᵢₙ minimal pressure
p_{S} boiling pressure
S boiling point
T_{ref} reference temperature
T_{S} boiling temperature

1-20. (canceled)

21. A method for the vacuum distillation of a liquid comprising the steps of:
evaporating at least one fraction of the liquid at a reducing pressure;
determining a vapor temperature correlating with a boiling temperature (T_{S}) by means of a temperature sensor and determining a pressure present at the time of the determination of the vapor temperature and correlating with a boiling pressure (p_{S}) with a pressure sensor; and
automatically determining a minimal pressure (pₘᵢₙ), which is not undercut in the distillation, by using the determined vapor temperature and the determined pressure.

22. The method in accordance with claim 21, said method being carried out with a rotary evaporator.

23. The method in accordance with claim 21, further comprising the step of associating a value pair comprising the determined vapor temperature and the determined pressure with a stored characteristic line to determine the minimal pressure (pₘᵢₙ).

24. The method in accordance with claim 23, wherein a pressure is associated with a predefined reference temperature (T_{ref}) by means of the characteristic line, with the pressure being determined as the minimal pressure (pₘᵢₙ).

25. The method in accordance with claim 21, further comprising the step of associating a value pair comprising the determined vapor temperature and the determined pressure with a stored array of characteristic lines to determine the minimal pressure (pₘᵢₙ).

26. The method in accordance with claim 25, wherein a pressure is associated with a predefined reference temperature (T_{ref}) by means of a characteristic line of the array of characteristic lines (31), with the pressure being determined as the minimal pressure (pₘᵢₙ).

27. The method in accordance with claim 21, wherein the determined vapor temperature and the determined pressure are determined on a start of the evaporation.

28. The method in accordance with claim 27, further comprising the step of recognizing the start of the evaporation on the basis of at least one measured value of at least one measurement parameter of the evaporation.

29. The method in accordance with claim 27, further comprising the step of recognizing the start of the evaporation on the basis of a time development of at least one measurement parameter of the evaporation.

30. The method in accordance with claim 27, further comprising the step of recognizing the start of the evaporation on the basis of at least one measured temperature value and/or a measured pressure value.

31. The method in accordance with claim 27, further comprising the step of recognizing the start of the evaporation on the basis of a time development of at least one measured temperature value and/or a measured pressure value.

32. The method in accordance with claim 21, further comprising the step of ending the distillation once the minimal pressure (pₘᵢₙ) is reached.

33. The method in accordance with claim 21, further comprising the steps of regulating a pressure tracking automatically using a continuously measured vapor temperature.

34. The method in accordance with claim 21, further comprising the steps of measuring a respective vapor temperature at a plurality of points arranged after one another in a flow direction of the vapor in order to determine a position of a condensation front of the vapor.

35. The method in accordance with claim 21, further comprising the steps of measuring a respective vapor temperature at a plurality of points arranged after one another in a flow direction of the vapor to regulate a position of a condensation front of the vapor.

36. The method in accordance with claim 21, further comprising the step of comparing a current pressure gradient with a predefined limit value to limit a drop of the pressure to a maximum permitted value.

37. The method in accordance with claim 21, wherein the vapor of at least the fraction condenses in a cooler and the condensate is collected in a collection vessel, with the collection vessel and/or condensate vapor rising from the collection vessel being cooled before a flowing back into the cooler.

38. A distillation apparatus for the vacuum distillation of a liquid, having a distillation vessel for the evaporation of at least one fraction of the liquid at a reducing pressure;
at least one temperature sensor for determining a vapor temperature correlating to a boiling temperature; and
a pressure sensor for determining a pressure present at the time of the determination of the vapor temperature and correlating with a boiling pressure,
the distillation apparatus being adapted to automatically determine a minimal pressure (pₘᵢₙ), which may not be undercut in the distillation, using the determined vapor temperature and the determined pressure.

39. The distillation apparatus in accordance with claim 38, configured as a rotary evaporator.

40. The distillation apparatus in accordance with claim 38, wherein the temperature sensor is arranged at the outlet of the distillation vessel and/or at the inlet of a cooler of the distillation apparatus.
